(19) United States
(12) Patent Application Publication
(10) Pub. No.: US 2014/0190137 A1
(43) Pub. Date: Jul. 10, 2014

(54) Media and Filter for Coastal and High Humidity Areas

(71) Applicant: TDC Filter Manufacturing, Inc., Niles, IL (US)

(72) Inventor: Yu Li, Bolingbrook, IL (US)

(73) Assignee: TDC Filter Manufacturing, Inc., Niles, IL (US)

(21) Appl. No.: 14/150,316

(22) Filed: Jan. 8, 2014

Related U.S. Application Data
(60) Provisional application No. 61/751,076, filed on Jan. 10, 2013.

(51) Int. Cl. B01D 46/10; B01D 46/12

(52) U.S. Cl. CPC B01D 46/10; B01D 46/125; B01D 46/103
USPC 55/486

(57) ABSTRACT

A filter media for use in coastal and other high humidity areas is provided. The media includes a first composite material layer having a melt-blown material layer, and a second composite material layer having a polyester layer and an electrospun nano fiber layer laminated to the polyester layer.

### CROSS-REFERENCE TO RELATED APPLICATIONS

The present application claims the benefit of U.S. Provisional Patent Application No. 61/751,076, filed Jan. 10, 2013, the contents of which are hereby incorporated by reference.

### FEDERALLY SPONSORED RESEARCH OR DEVELOPMENT

N/A

### FIELD OF THE INVENTION

The present invention generally relates to a filter media and filter adapted for coastal and other high humidity areas.

### DESCRIPTION OF THE PRIOR ART

A large variety of filters are utilized to remove particulates, pollutants and other undesirable materials from fluids, such as liquids or gas. The filters come in a variety of shapes and can include one of many types of filter media.

One known filter media is disclosed in U.S. Publication No. 2008/0302074 (“the '074 Publication”). The '074 Publication describes a multiple layer filter media for removing particulates from a fluid stream. The media includes a composite having a first thermoplastic layer, a second thermoplastic layer, and an expanded PTFE or ePTFE (expanded Polytetrafluoroethylene) membrane layer sandwiched between the first and second thermoplastic layers. The filter media disclosed in the '074 Publication is extremely expensive given the use of the PTFE membrane in the composite.

PTFE membranes are formed from stretching a PTFE film. Filters with PTFE membranes have several drawbacks. For example, PTFE membranes are very expensive. Additionally, PTFE membranes create high pressure drops.

Filters are needed, in particular, for gas turbines. Such turbines include air-intake components. However, contaminates in the air can cause problems with the turbine if not removed. For example, small particles in the intake air may deposit on the blades of the turbine and cause fouling of the compressor. Accordingly, it is necessary to provide an adequate filter system to remove such pollutants.

The common contaminants come from three main sources: water, dust and emissions. These contaminants can cause erosion, fouling, particle fusion and corrosion. Particularly the present invention is used for coastal, marine or offshore applications in which a high concentration of moisture and salt exist in the atmosphere. Salt is a primary cause for corrosion in a gas turbine. Also, a high concentration of salt can lead to fouling of the compressor blades. Conventional high efficiency filters do not prevent water penetration. Therefore, the water can pass through the filter media to the inlet of the gas turbine. This water can dissolve dry salt particles into salt solution, and transfer them from one side of the filter to the other, releasing them into the gas turbine. Additionally, the moisture can load the filters causing a remarkably high pressure drop. It is critical to design a high efficiency filter with moisture resistant and water control.

The present invention is designed to overcome problems associated with prior designs and provide an enhanced media and filter for coastal and other high humidity areas.

### SUMMARY OF THE INVENTION

The present invention provides a filter media for use in areas having high humidity and/or salt, such as coastal areas. The filter media can be used in a filter cartridge as an air-intake filter of a turbine machine.

In accordance with an embodiment of the invention, a filter media is provided having a first composite material layer and a second composite material layer. The second composite material layer includes a first layer and a second layer. The second layer of the first composite material is an electrospun nano fiber.

The first composite material layer is a melt-blown material, such as polypropylene. The first layer of the second composite material layer is spun bond material, such as polyester.

The electrospun nano fiber can be made from Polyvinylidene Flouride (PVDF) resin using an electro-spinning technique. The second layer of the second composite material layer is laminated to the first layer of the second composite material layer.

The first composite material is bound to the second composite material. In this regard, the first composite material layer can be laminated to the second composite material layer. An ultrasonic bonding technique can be used to laminate the first composite material layer to the second composite material layer.

In accordance with another embodiment of the invention, a filter having a filter media is provided. The filter comprises a filter cartridge housing a filter media. The filter media has a first composite material layer with a first surface and a second opposing surface. The first surface is exposed to the air flow direction. A second composite material layer is bonded to the first composite material layer. The second composite material layer has a first surface and a second surface. The first surface of the second composite material layer is positioned to confront the second surface of the first composite material layer. The second composite material layer has a first layer and a second layer laminated to the first layer. The second layer of the second composite material layer comprises nano fibers.

The filter media can include a web adhesive between the second layer and the first layer. Heat and pressure are utilized to laminate the first layer to the second layer.

The filter cartridge can be, for example, cylindrical, conical, a rectangular panel or a V-bank design.

Further aspects of the invention are disclosed in the description of the invention, including the Figures.

### BRIEF DESCRIPTION OF THE DRAWINGS

To understand the present invention, it will now be described by way of example, with reference to the accompanying drawings and/or attachments in which:

FIG. 1 is a schematic diagram of a partially exploded cross-section of filter media made in accordance with the present invention, the diagram also showing the direction of airflow;

FIG. 2 is a schematic diagram of a partially exploded cross-section of an alternative embodiment of filter media made in accordance with the present invention, the diagram also showing the direction of airflow;

FIG. 3 is perspective view of a box filter with filter media;

FIGS. 4A, 4B and 4C are perspective views of cartridge filters with filer media; and,

FIGS. 5A, 5B and 5C are perspective views of bank filters with filter media.

### DETAILED DESCRIPTION

While this invention is susceptible of embodiments in many different forms, there is shown in the drawings what will herein be described in detail preferred embodiments of the invention with the understanding that the present disclosure is to be considered as an exemplification of the principles of the invention and is not intended to limit the broad aspect of the invention to the embodiments illustrated.

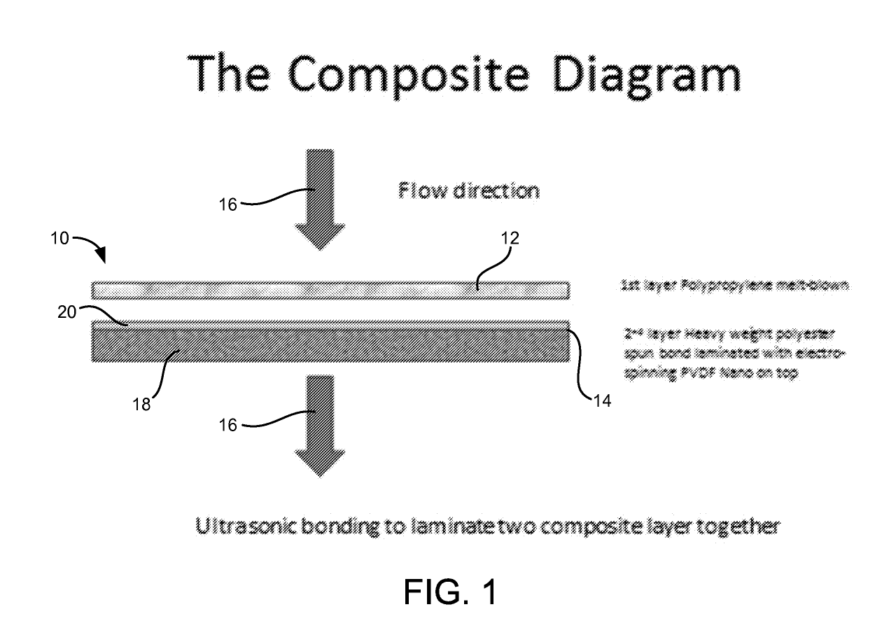

As illustrated in the partially exploded cross-sectional view of FIG. 1, a filter media 10 is provided having a first composite material layer 12 and a second composite material layer 14. Arrows 16 show the fluid flow direction through the composite material layers 12, 14 of the filter media 10. The filter media 10 is typically pleated for use in a filter cartridge or panel filter.

The first composite material layer 12 is a melt-blown layer, such as a polypropylene melt-blown. Alternatively, the first composite material 12 could be polyester, nylon, polyethylene or PTFE. The first composite material layer 12 acts as a protective layer for the filter media 10. In this regard, the first composite material layer 12 protects the filter media 10 during pleating and other handling of the filter media 10.

The first composite material layer 12 has a low surface energy. This helps repel water droplets. Specifically, the first composite material layer 12 functions as a coalescer to repel water droplets and to grow small water droplets into larger water droplets. Gravity forces will pull the droplets downward vertically (e.g., to a drain).

The first composite material layer 12 is formed to have small fibers randomly laid to create a tortuous path. This tortuous path helps trap contaminants (e.g., dirt).

The first composite material layer 12 has an air permeability of 40 to 90 cfm, and more preferably 60 to 70 cfm. The first composite material layer 12 has a basis weight of 10 to 60 gsm, and more preferably 20 to 40 gsm.

The fibers of the first composite material layer 12 range from 1-7 microns. The first composite material layer 12 has a thickness of about 0.40 to 0.70 mm, and more preferably from 0.46 to 0.66 mm. The tortuous path created by the fibers and the depth of the layer 12 provides a contaminant holding capacity that is significantly increased over prior filter media.

The second composite material layer 14 includes a first layer 18 of a heavyweight polyester spun-bond material. Alternatively, the first layer could be nylon or polypropylene.

A PVDF (Polyvinylidene Fluoride) nano fiber is laminated as a second layer 20 to the top (i.e., into the flow direction 16) of the first layer 18. The PVDF nano fiber is created by electro-spinning techniques. The electrospun PVDF nanofiber has a low surface tension and provides a hydrophobic property to the second composite material layer 14. The hydrophobic property of the layer stops salt water solution or tiny water aerosols.

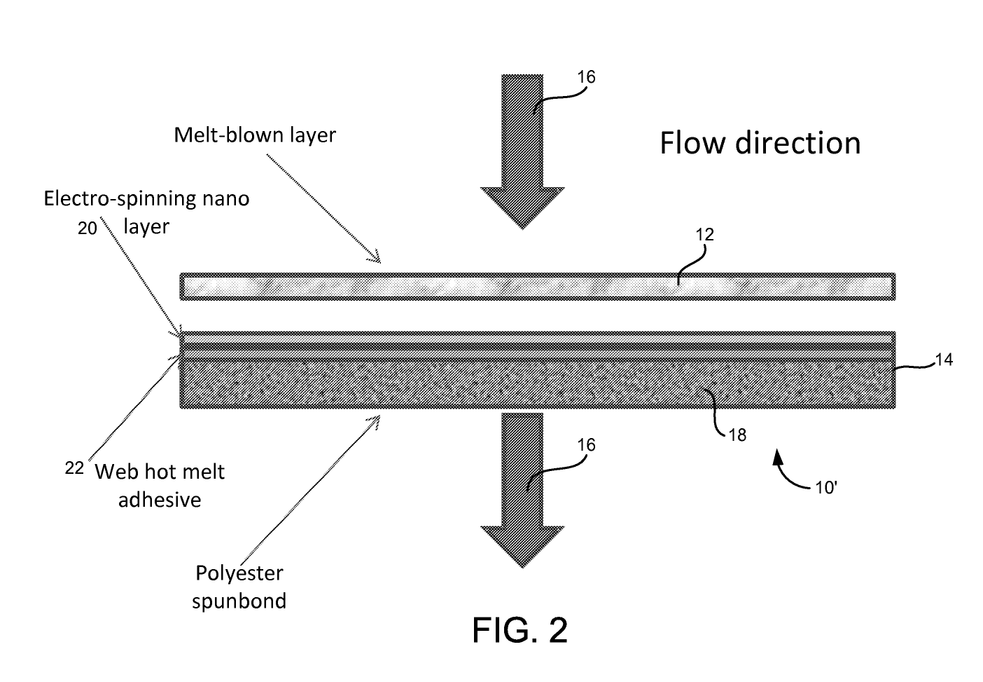

As illustrated in the embodiment of the filter media 10′ shown in FIG. 2, the PVDF nano fiber 20 can be laminated on the polyester spunbond via a bi-component web adhesive layer using heat and pressure, to create a hot melt web adhesive layer 22 produced in a nonwoven form. Web adhesives handle like a fabric, facilitating both intermittent and continuous processes.

The second composite material layer 14 has an air permeability of about 3 to 8 cfm, and more preferably 5.4 cfm. The second composite material 14 has a thickness of about 0.3 to 0.8 mm, and more preferably 0.52 mm. The second composite material layer 14 has a basis weight of about 140 to 200 gsm, and more preferably 170 gsm.

The first composite material layer 12 is bound together with the second composite material layer 14. Preferably, the first and second composite material layers 12, 14 are laminated together. This can be done with an ultra-sonic bonding technique, or other similar or suitable techniques.

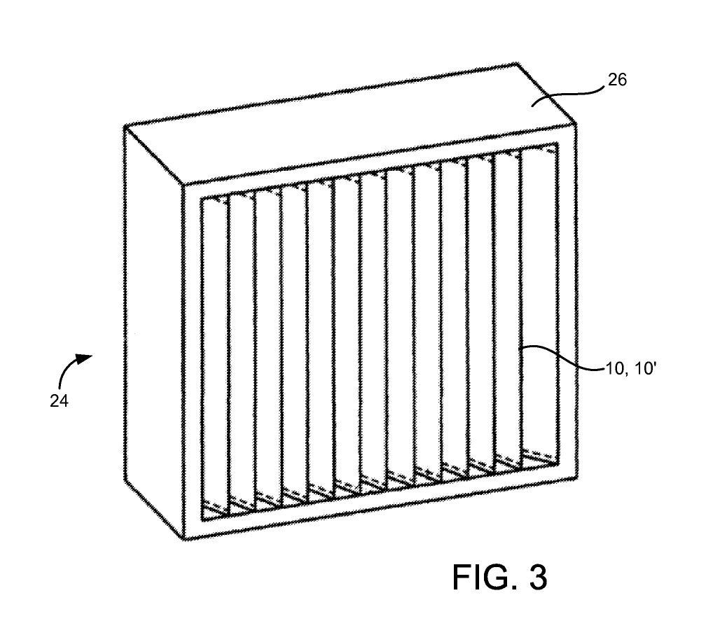

The filter media 10, 10′ having first and second composite material layers 12, 14, can be pleated and/or placed in any of a variety of filter cartridges or filter holders. Examples of some of the filter cartridges or holders are illustrated in FIGS. 3-5.

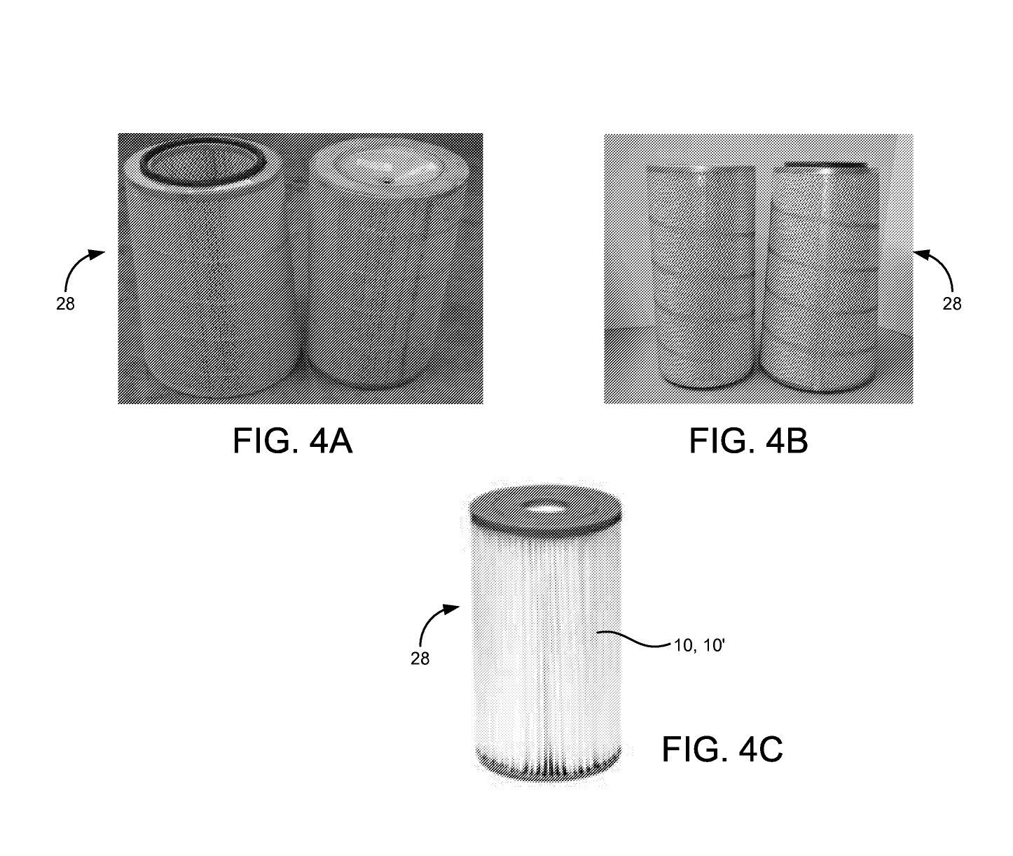

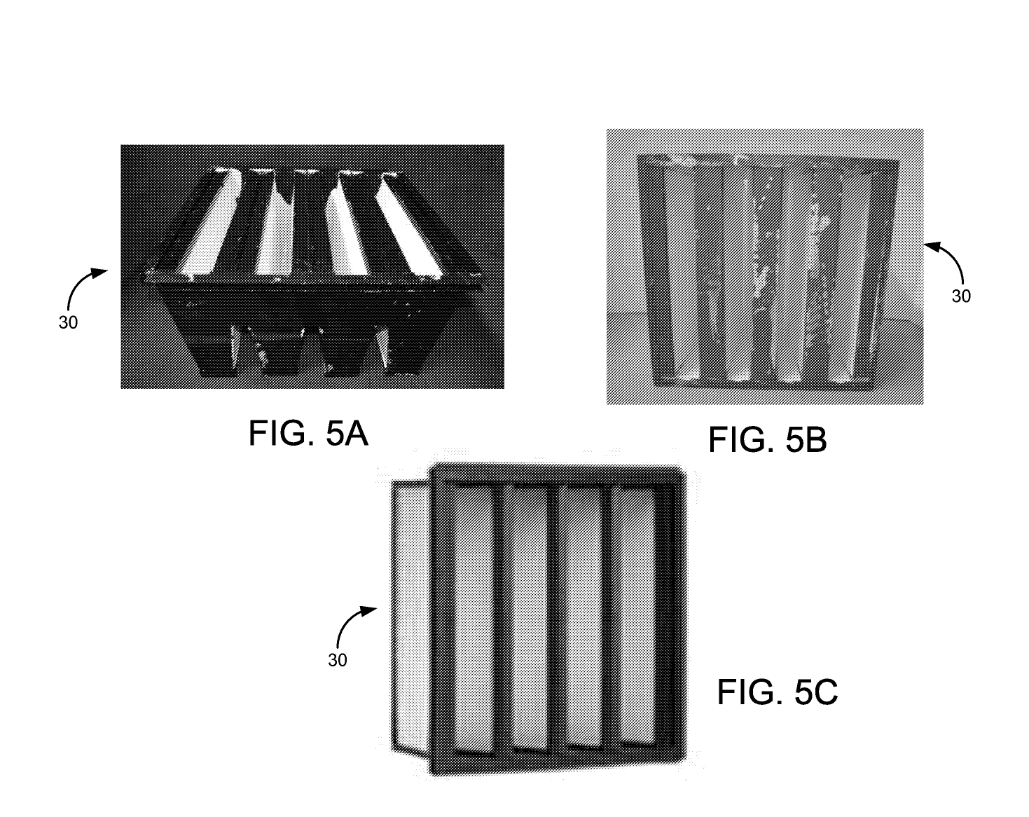

In particular, FIG. 3 shows the filter media 10, 10′ in a panel filter 24 having a square or rectangular frame 26 surrounding the filter media 10, 10′. FIGS. 4A, 4B and 4C show the filter media 10, 10′ in a cylindrical or conical cartridge filter 28. FIGS. 5A, 5B and 5C show the filter media 10, 10′ in a mini V-bank filter 30. The various filters 24, 28 and 30 can be placed in a variety of apparatuses requiring filtration of airflow.

Specifically, the filters 24, 28 or 30 could be used as an air-intake filter for a turbine. Preferably, the filter frame or cartridge with the described media is used for a turbine located in a coastal area or other high humidity area. The filter cartridge is useful for preventing salt and other contaminants from reaching and adversely affecting internal portions of the gas turbine.

In accordance with one embodiment of the invention, two composite layers are bonded together by ultrasonic bonding. The first composite layer is 30 gram per square meter polypropylene fibers. The fiber size ranges from 1 to 8 micron. The first composite layer functions as a water aerosol coalescing, prefilter for dust holding, and protection of the second composite layer.

The second composite layer is PVDF nano fiber on polyester spunbond laminated together by bi-component polyester. The basis weight of second composite layer is 176 gram per square meter. The second composite layer has a Frazier air permeability of 8 cfm, and DOP efficiency of 99.96% at 0.3 micron at a flow rate of 5.3 cm/s.

The resulting overall media composite formed by combining the first and second composite layers has the following properties: air permeability 8 cfm, water entry pressure 48.4″W.G. (inch water column), and DOP efficiency of 99.97% at 0.3 micron at flow rate 5.3 cm/s.

Many modifications and variations of the present invention are possible in light of the above teachings. It is, therefore, to be understood within the scope of the appended claims the invention may be protected otherwise than as specifically described.

I/we claim:

1. A filter media comprising:
a first composite material layer; and,
a second composite material layer including a first layer and a second layer, the second layer comprising electrospun nano fibers.

2. The filter media of claim 1 wherein the first composite material layer is a melt-blown material.

3. The filter media of claim 2 wherein the melt-blown material is polypropylene.

4. The filter media of claim 1 wherein the first layer of the second composite material layer is spun bond material.

5. The filter media of claim 4 wherein the spun bond material is polyester.

6. The filter media of claim 1 wherein the electrospun nano fibers are formed from PVDF.

7. The filter media of claim 1 further comprising a bi-component web adhesive connecting the electrospun nano fibers to the composite material layer.

8. The filter media of claim 1 wherein the first composite material is bound to the second composite material.

9. The filter media of claim 7 wherein the first composite material layer is laminated to the second composite material layer.

10. The filter media of claim 8 wherein the first composite material layer is laminated to the second composite layer by an ultrasonic bonding technique.

11. A filter comprising:
a filter cartridge housing a filter media,
the filter media having a first composite material layer with a first surface and a second opposing surface wherein the first surface is exposed to the air flow direction, and a second composite material layer bonded to the first composite material layer, the second composite material layer having a first surface and a second surface wherein the first surface of the second composite material layer confronts the second surface of the first composite material layer, the second composite material layer having a first layer and a second layer laminated to the first layer, the second layer of the second composite material layer comprising nano fibers.

12. The filter of claim 11 wherein the first composite material layer is a melt-blown material.

13. The filter of claim 12 wherein the melt-blown material is nylon.

14. The filter of claim 12 wherein the melt-blown material is polyester.

15. The filter of claim 12 wherein the melt-blown material is polyethylene.

16. The filter of claim 11 wherein the first layer of the second composite material layer is a polyester spun-bond material.

17. The filter of claim 11 wherein the second composite material layer of the filter media includes a web adhesive between the second layer and the first layer.

18. The filter of claim 11 wherein the filter cartridge is a panel.

19. The filter of claim 11 wherein the filter cartridge is conical.

20. The filter of claim 11 wherein the filter is a V-bank.
